(19) United States
(12) Patent Application Publication
(10) Pub. No.: US 2026/0276437 A1
(43) Pub. Date: Sep. 17, 2026

(54) IMPROVEMENTS IN FIBRE OPTIC DISTRIBUTED ACOUSTIC SENSING

(71) Applicant: AVA Risk Group Limited, Mulgrave, Victoria (AU)

(72) Inventor: Alaster Meehan, Mulgrave, Victoria (AU)

(21) Appl. No.: 19/162,599

(22) PCT Filed: Mar. 7, 2023
(86) PCT No.: PCT/AU2023/050150

§ 371 Date: Sep. 5, 2025

(51) Int. Cl. G01H 9/00; G01D 5/353; G06N 20/00

(52) U.S. Cl. CPC G01H 9/004; G01D 5/35361; G06N 20/00

(57) ABSTRACT

A computer-implemented method for identifying events of interest detected by a distributed sensor system, the method comprising the steps of: obtaining a raw data array generated from raw measurements made by a distributed sensor system comprising a fibre optic cable optically coupled to a light source and a light signal detector for a plurality of discrete time intervals, wherein each raw measurement is processed to create a plurality of bins, wherein each bin is uniquely associated with a location along the fibre cable and comprises signal data associated with said location, and wherein the raw data array comprises a time axis corresponding to the plurality of discrete time intervals and a location axis corresponding to the plurality of bins; separately processing the raw data array according to a plurality of predefined filters, where each filter is unique and receives the raw data array as an input and generates a filtered array as an output; processing the plurality of filtered arrays using an object identifier, wherein the object identifier is configured to: treat the plurality of filtered arrays as separate channels of an image and thereby processes the plurality of filtered arrays as a multichannel image, perform a preconfigured image recognition operation to identify objects, within the multichannel image, corresponding to one or more predefined target events, and in response to identifying one or more objects corresponding to the one or more predefined target events, generate a detection event for the, or each, identified object identifying at least a location along the fibre optic cable associated with the presence of the object; wherein the one or more target events each correspond to a particular type of event of interest intended for detection by the distributed sensor system, and wherein each object is representative of a signal detected by the distributed sensor system at the corresponding location, and related system and apparatus.

### FIELD OF THE INVENTION

The invention relates to a computer-implemented method for identifying events of interest detected by a distributed sensor system, such as a Distributed Acoustic Sensing (DAS) system.

### BACKGROUND TO THE INVENTION

Fibre optic Distributed Acoustic Sensing (DAS) systems have become the technology of choice for a number of long-distance sensing applications particularly as physical intrusion detection sensors. Their high sensitivities coupled with their long reach as a passive sensor which does not require any power in the field give them a competitive edge over conventional sensors. Typical applications include fence perimeter sensing systems, covert buried sensing systems, as well as the protection for buried infrastructure such as pipelines or communications links. More recently, DAS systems have attracted significant interest as distributed sensors in Smart City applications to provide situational awareness, as well as condition monitoring applications such as conveyor health monitoring and structural integrity monitoring.

For intrusion detection applications, the three key performance parameters of all DAS systems are the Probability of Detection (POD), the Nuisance Alarm Rate (NAR), and the False Alarm Rate (FAR). POD is related to the sensitivity of the system and provides an indication of a system's ability to detect an intrusion within the protected area. A nuisance alarm is any alarm which is generated by an event that is not of interest. A false alarm refers to an alarm generated by the system electronics and is not related to the sensor or an event. False alarms can be minimized through appropriate system design. Nuisance alarms are typically generated by environmental conditions such as rain, wind, snow, wildlife and vegetation, as well as man-made sources such as traffic crossings, industrial noises and other ambient noise sources. While increasing the sensitivity of a system increases its POD, it will inevitably increase it sensitivity to nuisance events thereby increasing the NAR.

This interdependency between POD, NAR and sensitivity can be optimised through the use of advanced signal processing techniques that have the ability to discriminate between events of interest and other nuisance events that are not of interest.

To extract information of interest whilst ignoring unwanted nuisances caused by environmental noise can require several levels of processing. For intrusion detection systems, one of the biggest challenges is to detect events in real-time. Typically, the rate of data received from a DAS unit is very high and the generated raw data is usually difficult to interpret. This raw data is usually pre-processed to create a DAS waterfall showing event statistics. A typical representation of the backscattered signal as interrogated by a DAS system is by means of a rolling time-distance waterfall which plots a signal, or event statistic, for every sensing segment, or bin, of the sensing fibre over a given time period.

Most processing techniques to date have relied on conventional approaches of thresholding and hand coding features to look for regions of interest. Initial machine learning methods have been applied to these hand coded features, however modern approaches to machine learning use Convolutional Neural Networks (CNN) to determine what features are important to distinguish areas of interest from nuisances generated from environmental noise.

There are examples in the literature where object detection algorithms have been adapted to various DAS applications such as seismic detections (References [8,9]) or for pipeline monitoring applications (Reference [10]). In each of these applications an object detection algorithm such as YOLO (Reference [2]) was adapted and trained to detect features on DAS data. In each of these cases single-channel images were used.

### SUMMARY OF THE INVENTION

According to a first aspect of the present invention, there is provided a computer-implemented method for identifying events of interest detected by a distributed sensing system, the method comprising the steps of: obtaining a raw data array generated from raw measurements made by a distributed sensing system comprising a fibre optic cable optically coupled to a light source and a light signal detector for a plurality of discrete time intervals, wherein each raw measurement is processed to create a plurality of bins, wherein each bin is uniquely associated with a location along the fibre cable and comprises signal data associated with said location, and wherein the raw data array comprises a time axis corresponding to the plurality of discrete time intervals and a location axis corresponding to the plurality of bins; separately processing the raw data array according to a plurality of predefined filters, where each filter is unique and receives the raw data array as an input and generates a filtered array as an output; processing the plurality of filtered arrays using an object identifier, wherein the object identifier is configured to: treat the plurality of filtered arrays as separate channels of a multichannel image and thereby processes the plurality of filtered arrays as a multichannel image, perform a preconfigured image recognition operation to identify objects, within the multichannel image, corresponding to one or more predefined target events, and in response to identifying one or more objects corresponding to the one or more predefined target events, generate a detection event for the, or each, identified object identifying at least a location along the fibre optic cable associated with the presence of the object; wherein the one or more target events each correspond to a particular type of event of interest intended for detection by the distributed sensing system, and wherein each object is representative of a signal detected by the distributed sensing system at the corresponding location.

Typically, each object corresponds to vibrations detected by the fibre optic cable at the corresponding location along its length. The distributed sensing system may be utilised for intrusion detection and at least one target event may correspond to an intrusion event.

The method is optionally implemented by a controller configured to operate the light source and the light signal detector to generate the raw measurements. In an alternative option, the method is implemented by a processing server in data communication with a controller, the controller being configured to operate the light source and the light signal detector to generate the raw measurements and communicate the raw measurements to the processing server.

The object identifier optionally comprises a pretrained machine learning algorithm for implementing the preconfigured image recognition operation. The machine learning algorithm may be trained using a training set comprising a plurality of annotated filtered arrays derived from raw data training arrays, each raw data training array may comprise one or more events of interest represented in its raw measurements, and each filtered array is annotated to indicate a predefined target event type associated with the, or each, event of interest. Each annotation may include localisation information indicated the location of the event of interest within the associated filtered arrays. Annotations may be provided by annotating a multichannel training image derived from the filtered arrays derived from a particular raw data training array, each channel of the multichannel image thereby may correspond uniquely to an output of one of the plurality of predefined filters. Optionally, an optimisation procedure is utilised to determine an optimal filter type and/or at least one optimal parameter value for at least one of the predefined filters, and/or to determine an optimal number of predefined filters. The optimisation procedure may be subject to constraints selected from one or more of: allowable filter types, allowable parameter values for particular filter types, and/or allowable numbers of filters.

The raw data array may comprise a signal value derived from the measurement data for each bin at each discrete time interval.

Optionally, at least one predefined filter generates a filtered array comprising an event statistic value for each bin associated with one or a continuous range of discrete time intervals. The event statistics may be generated using a calculation comprising one or more of: a Frequency Band Ratio (FBR), a power spectral density, a level crossing calculation, a raw measurement amplitude, and a raw measurement phase. At least two filters may utilise a same event statistic generation method differentiated by a setting of at least one parameter associated with the event statistic generation method. The at least two filters may differ according to a frequency range parameter when using a Fast Fourier Transform. The at least two frequency range parameters may be non-continuous in the frequency domain. At least two filters may differ according to one or more wavelet transform parameters, such as frequency range, cut-off frequency, and edges. The filters may differ according to one or more of: a discrete cosine transform (DCT), a discrete sine transform (DST), and one or more other mathematical transform parameters. At least two filters may utilise a different event statistic generation method.

One or more of the filtered arrays may be scaled to provide a consistent size for each filtered array for creating the multichannel image.

Optionally, in response to generating a detection event, the method comprises communicating a notification to a recipient device providing information about the detection event including at least a location along the fibre optic cable associated with the detection event.

In an embodiment, the distributed sensor system is an amplitude based Distributed Acoustic Sensing (DAS) system. Other embodiments may comprise a distributed sensor system selected from: a Distributed Temperature Sensing (DTS) system, a Brillouin Optical Time-Domain Reflectometer (BOTDR) system, and a true-phase based Distributed Acoustic Sensor (DAS) system.

The step of separately processing the raw data array according to a plurality of predefined filters may comprise generating slices of the filtered arrays, such that each slice is processed separately by the object identifier. The slices may be arranged such that adjacent slices comprise overlapping portions of the filtered arrays.

In an embodiment, there are three predefined filters. In an alternative embodiment, there are four or more predefined filters corresponding to a multispectral image. In another embodiment, there are two predefined filters.

According to a second aspect of the present invention, there is provided a computer-implemented method for identifying events of interest detected by a distributed sensor system, the method comprising the steps of: obtaining a plurality of filtered arrays, each filtered array obtained as an output of an associated filter applied to a raw data array, wherein each filter is unique, and wherein the raw data array is generated from raw measurements made by a distributed sensor system comprising a fibre optic cable optically coupled to a light source and a light signal detector for a plurality of discrete time intervals, wherein each raw measurement is processed to create a plurality of bins, wherein each bin is uniquely associated with a location along the fibre cable and comprises signal data associated with said location, and wherein the raw data array comprises a time axis corresponding to the plurality of discrete time intervals and a location axis corresponding to the plurality of bins; and processing the plurality of filtered arrays using an object identifier, wherein the object identifier is configured to: treat the plurality of filtered arrays as separate channels of a multichannel image and thereby processes the plurality of filtered arrays as a multichannel image, and perform a preconfigured image recognition operation to identify objects, within the multichannel image, corresponding to one or more predefined target events, wherein the one or more target events each correspond to a particular type of event of interest intended for detection by the distributed sensor system, and wherein each object is representative of a signal detected by the distributed sensor system at the corresponding location.

According to a third aspect of the present invention, there is provided a computer-implemented method for ongoing detection of events of interest, the method comprising the steps of: continuously obtaining raw measurements from a distributed sensing system; periodically performing the method of the first aspect or second aspect, using a most recent set of the obtained raw measurements to generate the raw data array.

According to a fourth aspect of the present invention, there is provided a controller configured to operate a light source and light signal detector of a distributed sensing system, the controller configured to obtain raw measurements from the light signal detector, and further configured to implement the method of the first aspect, the second aspect, or the third aspect, wherein the controller generates the raw signal array from the raw measurements.

According to a fifth aspect of the present invention, there is provided a distributed sensing system comprising a controller, a light source, a light signal detector, and a fibre optic cable, wherein the light source and light signal detector are optically coupled to the fibre optic cable an wherein the controller is configured to operate the light source and light signal detector, the controller configured to obtain raw measurements from the light signal detector, and further configured to implement the method of the first aspect, the second aspect, or the third aspect, wherein the controller generates the raw signal array from the raw measurements.

According to a sixth aspect of the present invention, there is provided a computer program comprising code configured to cause a processor to implement the method of the first aspect, the second aspect, or the third aspect when said code is executed by said processor.

According to a seventh aspect of the present invention, there is provided a computer readable storage medium having stored thereof the computer program of the sixth aspect.

As used herein, the word “comprise” or variations such as “comprises” or “comprising” is used in an inclusive sense, i.e. to specify the presence of the stated features but not to preclude the presence or addition of further features in various embodiments of the invention.

### BRIEF DESCRIPTION OF THE DRAWINGS

Embodiments of the invention will be described in conjunction with the following drawings in which:

FIG. 1 illustrates an example Coherent Optical Time Domain Reflectometer distributed sensor system arrangement;

FIG. 2 is a schematic diagram illustrating the need to distinguish between nuisance and intrusion vibrations detected by a covert buried sensor;

FIG. 3 is an example of raw shot data from the sensing arrangement of FIG. 2;

FIG. 4 is a schematic diagram illustrating how the signal of FIG. 3 is filtered;

FIGS. 5A and 5B show a method for identifying target events according to an embodiment;

FIG. 6 shows a waterfall plot illustrating an observable pattern (an object) corresponding to a target event;

FIG. 7 shows slices for use in object identification;

FIG. 8 shows an arrangement for communicating notifications;

FIG. 9 shows a method for ongoing event detection according to an embodiment;

FIG. 10 shows an arrangement in which event detection is performed by a processing server in communication with a controller;

FIG. 11 shows three different filtered arrays corresponding to different filters applied to the same raw data, as well as a composite image of the filtered arrays;

FIGS. 12A and 12B show a comparison between real-world experimental data subject to a single channel object identification approach and a multichannel object identification approach; and

FIGS. 13A and 13B show a comparison of walk signal detection in real-world experimental data subject to an existing technique and a multichannel object identification approach.

### DESCRIPTION OF EMBODIMENTS

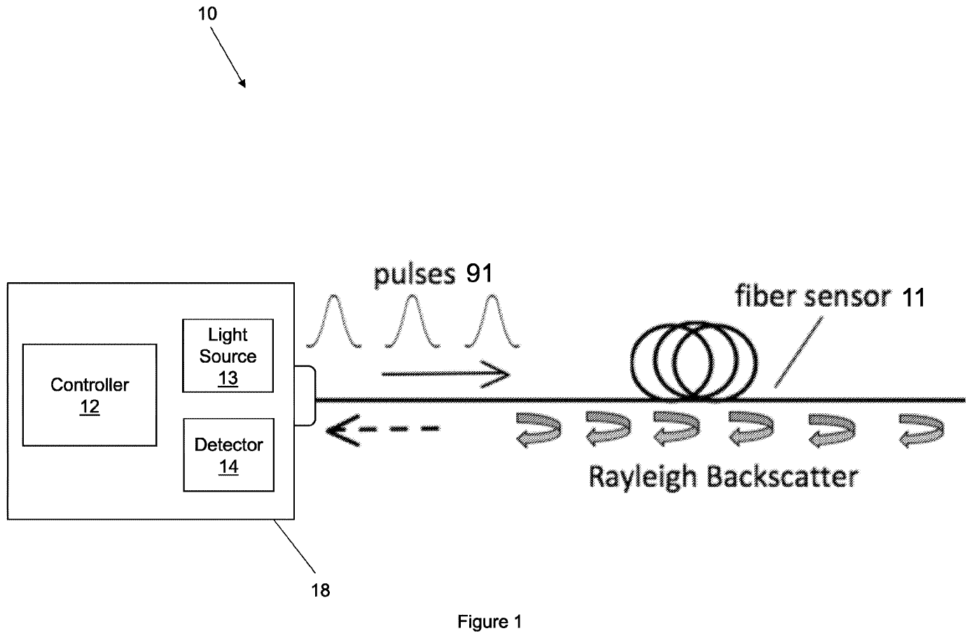

FIG. 1 shows an exemplary event detection system 10 utilising a distributed sensor system, in this case corresponding to a fibre optic-based Distributed Acoustic Sensing (DAS). The system 10 comprises a controller 12, a light source 13 (for example, a laser source), a light signal detector 14 (herein detector 14), and a fibre optic cable 11, such that the light source 13 is coupled to the fibre optic cable 11 and configured to generate light pulses for transmission down the fibre optic cable 11 (herein fibre cable 11). Additionally, the light signal detector 14 is arranged to receive a light signal generated along the length of the fibre optic cable 11, thereby generate measured signal data. The system 10 can comprise, for example, the Applicant's Aura Ai-2 controller embodying the controller 12, the light source 13, and the light signal detector 14. The controller 12 is interfaced with both the light source 13 and the light signal detector 14. As shown in FIG. 1, the light source 13 and detector 14 are embodied in a housing 18 also comprising the controller 12, thereby providing a unitary device for coupling to the fibre cable 11.

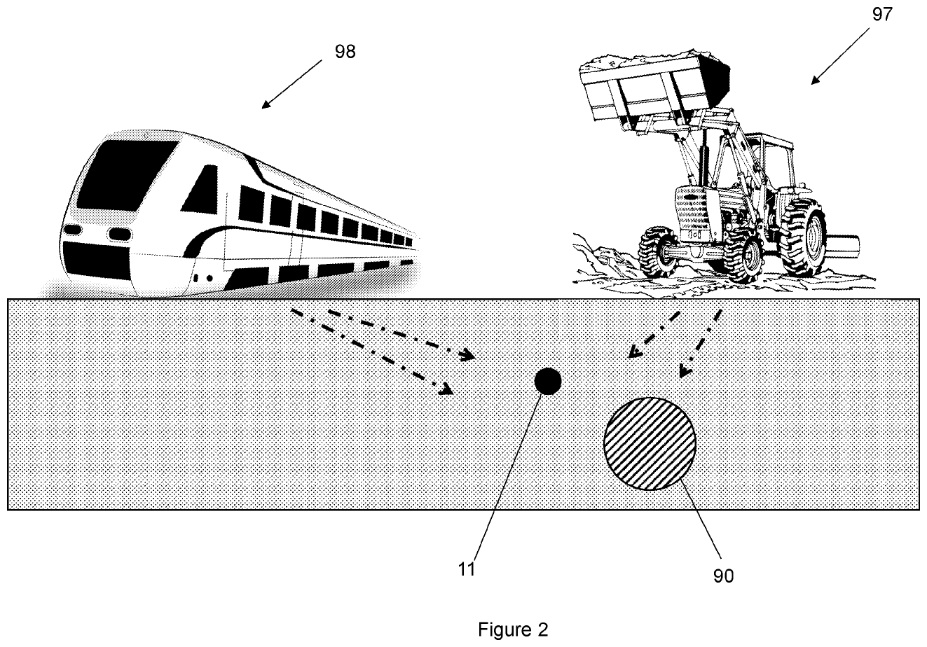

Embodiments described herein relate to an event detection, where the event is associated with vibrations which can affect the propagation of light down the fibre optic cable 11. For example, the system 10 may be suitable for buried intrusion detection systems. FIG. 2 illustrates an example scenario in which embodiments described herein can be employed. In order to protect a buried pipeline 90, a sensor in the form of fibre cable 11 is buried next to the pipe line 90. In an example, the fibre cable 11 is buried at a depth of 100 mm to 150 mm. In another example, the fibre cable 11 is buried at a depth of 100 mm to 300 mm. In this example, an event of interest is digging (e.g. by a person or machinery) near the pipeline 90 as it has the potential to damage the pipeline 90. On the other hand, a nuisance signal may be generated by vibrations such as passing transport 98 (i.e. a “nuisance event”)—these nuisance signals are “real” in that the nuisance event generates a real vibration, however, these are not events of interest as there is no risk of damage to the pipeline 90. Other example applications include: fence-mounted intrusion detection systems; the use of available fibres in a fibre base communications network to detect unauthorised access or intrusions; and monitoring surrounding acoustic vibrations for situational awareness.

For a typical DAS implementation, in use, pulses of light are continuously propagated down the fibre cable 11 by the light source 13 coupled to a source end of the fibre cable 11. The natural Rayleigh scattering process in the fibre cable 11 causes a small portion of this light to scatter or reflect back towards the detector 14 that is also appropriately placed at the source end to receive these scattered signals. Using this technique, the fibre cable 11 effectively acts as a series of distributed sensing channels or ‘microphones’, sequentially set up along the sensing fibre, for total distances up to 70 km or more. Each individual sensing channel effectively forms an individual interferometer that is sensitive to vibrations. By detecting and monitoring the backscattered signal as well as the pulse timing information, an acoustic perturbation on the fibre cable 11 can be detected and located to a high precision. The principle behind a DAS system, which is also often referred to as a phase sensitive OTDR system, is illustrated in FIG. 1.

Typically, the light source 13 is controlled by the controller 12 to inject a series of pulses 91 into the optical fibre 11. Correspondingly, the detector 14 is controlled by the controller 12 to monitor the return light signal caused by Raleigh backscatter within the fibre cable 11. By processing the return signal, it is possible to detect changes in the backscatter when a disturbance acts on the fibre cable 11. In an example, the controller 12 is configured to control the light source 13 to output optical pulses with a pulse width of 100 ns and peak power of 125 mW at a rate of 2000 to 5000 pulses per second. As each pulse 91 propagates along the fibre cable 11, the controller 12 is configured to control the signal detector 14 to sample the backscatter at 200 million times a second (200 MHz). The effect of these parameters is a sensing channel for every 0.5 m of length of the fibre cable 11.

The detector 14 is configured to digitise the return signal to construct a raw signal (corresponding to measured signal data). A complete traversal of a pulse 91 along the entire length of the fibre cable 11 and receipt of the entire corresponding backscattered signal is known as a ‘shot’. A shot is therefore an interrogation of the fibre sensor (corresponding to the entire fibre cable 11) by a single pulse 91.

The controller 12 comprises a processor interfaced with a memory and optionally a data interface, which can provide the controller 12 with data communications with a network (which can comprise the Internet or can be limited to a local intranet). The processor can comprise one or more Central Processing Units (CPU). The processor can also be embodied in a microcontroller, in which the memory and optionally data interface are also embodied. The processor can be implemented using a Field-Programmable Gate Array (FPGA). Additionally, the processor can be embodied within combinations of different elements. It is also anticipated that some or all of the controller functionality is provided by an off-site processing service, such as a cloud service. The processor may comprise separate processing elements dedicate to certain functions, for example, a processing element for operating the light source 13 and detector 14, and another processing element for operating the methods herein desired. The term “processor” should be understood, therefore, to encompass multiple processors and may correspond to a CPU processor and/or a GPU processor. Similarly, the memory may comprise a single logical memory or separate dedicated memories. Additionally, the memory typically comprises a volatile memory and a non-volatile memory.

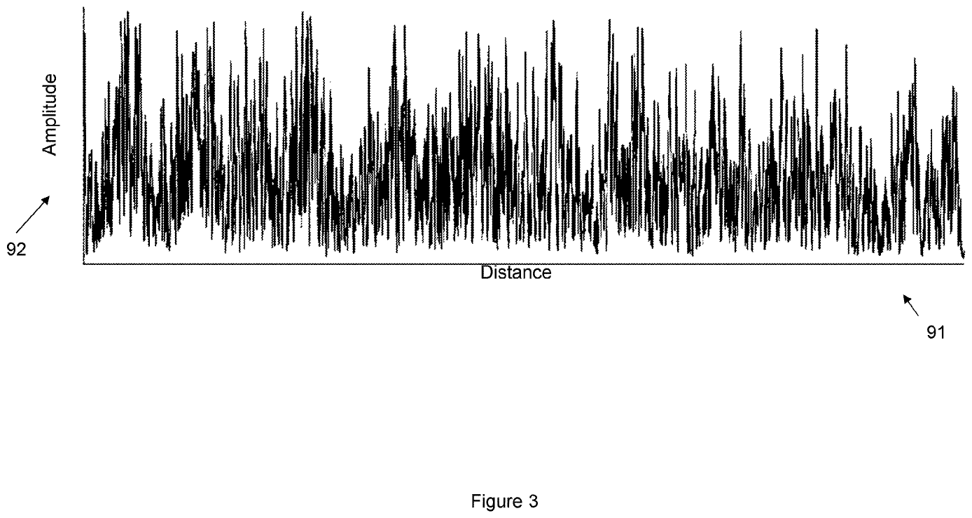

The controller 12 is configured to divide each shot into predefined lengths (e.g. 0.5 m sections) of the fibre cable 11 (termed “sensor bins” or simply “bins”). An example of a raw shot is shown in FIG. 3, where the horizontal axis 91 is distance in metres and the vertical axis 92 is amplitude in ADC units (ADC=analogue-to-digital converter). Each bin is therefore effectively uniquely associated with a position along the fibre cable 11. Each bin is effectively a measure of disturbances (in particular, vibrational disturbances) in the fibre cable 11 local to the corresponding position-therefore, the fibre cable 11 can be thought of as a plurality of discrete “sensors” or “microphones” spread along the entirety of the fibre cable 11.

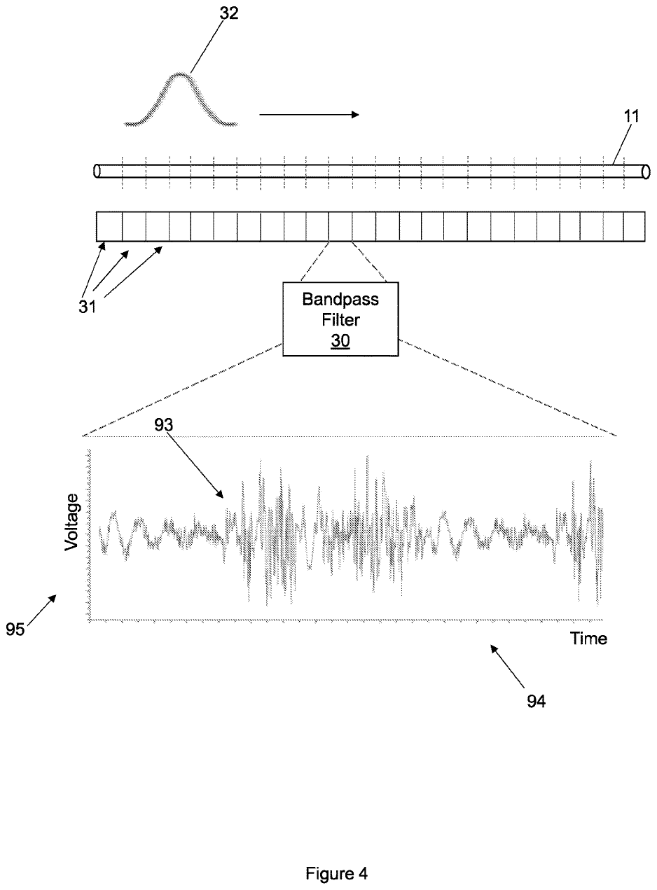

FIG. 4 is a schematic diagram that illustrates that after the raw signal is created for each bin 31 of a shot 32, it is then pre-filtered with a suitable filter or filters (e.g. a bandpass filter 30) in order to produce, for each bin 31, a pre-filtered signal in which high frequency noise is removed, such noise being a common feature of COTDR signals. The pre-filtered signal 33 looks similar to an interferometric signal. As shown, in FIG. 4, the horizontal axis 94 of the filtered signal is time (ms) and the vertical axis 95 is a measure of signal strength, in this case, in terms of Voltage (V). Please note that, for clarity of disclosure, the terms “bin” and “shot” are not generally labelled with a numerical reference herein.

Typically, the pre-filtered signal is further processed in order to generate an “event statistic” associated with each bin. An event statistic is, in effect, a value (or values) that represent the strength of a detected signal at the locality of the bin. For example, for intrusion detection, the measured parameter is typically a strength of vibrations at the locality of the bin, and the event statistic represents a signal strength (e.g. a vibration strength which may correspond to a vibration amplitude). In another example, the event statistic may correspond to a phase of the signal at the particular location corresponding to the bin. The purpose of the further processing is to isolate real signals associated with the measured parameter(s) from noise.

For example, Applicant's earlier patent application, PCT/AU2019/050303, published as WO 2019/191815 A1 on 10 Oct. 2019 (Reference [5]), describes a method for generating event statistics for each bin which accounts for local noise (referred to herein as the Frequency Band Ratio (FBR) method). The entire content of this disclosure is incorporated herein by reference. The method describes providing the raw data as an input and generating an output data structure in which blocks are analysed for each bin, each block comprising a plurality of shots (e.g. 400). The blocks are passed through a domain transformation, such as Fast Fourier Transform (FFT) or wavelet transformation, and then subjected to further processing. The output is an “event statistic” for each block, essentially a value representing the strength of vibrations at the bin during the time period covered by the block. The output can therefore be a smaller data set to the input, due to each block effectively substituting for a plurality of individual shots.

The FBR method has one or more selectable parameters. For example, different domain transformations can be utilised (itself representing a selectable parameter), such as FFT or wavelet transforms, and the resulting domain is divided into noise domain and a signal domain, where the signal domain is expected to comprise energy associated with an event of interest (and is a selectable parameter) and the noise domain is only expected to comprise system noise (which may be a selectable parameter). Block size can be a selectable parameter.

Other methods of generating event statistics are known, for example, these can be selected from one or more of a number of signal properties such as amplitude, power spectral density, and level crossings (see Reference [4] for disclosure of a level crossing methodology). As with the FBR method, these typically include one or more settable parameters although this is not necessarily required.

Also, for example, filters may differ in selection of one or more of: a discrete cosine transform (DCT), a discrete sine transform (DST), and one or more other mathematical transform parameters.

These known techniques provide a mechanism for identifying “real signals” and distinguishing these from background noise (noise may otherwise lead to false alarms). However, these techniques are not suitable for distinguishing real signals that corresponds to events of interest and those corresponding to nuisance signals, as each produce actual vibrations.

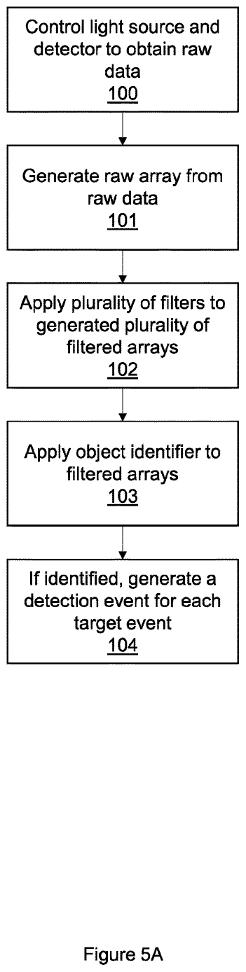

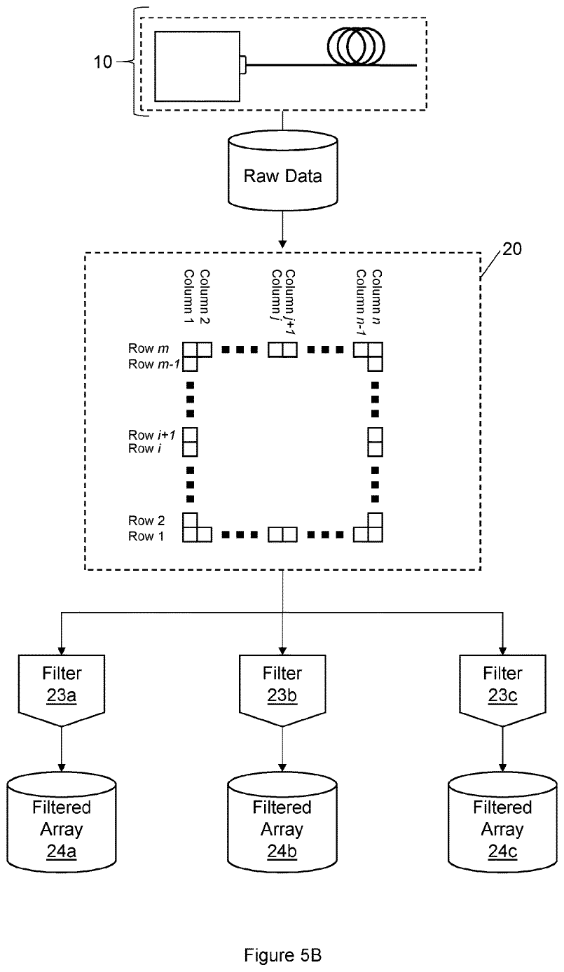

FIG. 5A shows a method for analysing raw data (e.g. COTDR data) generated by system 10 for identifying target events (e.g. in the context of intrusion detection, an intrusion by a person, animal, or machinery; for brevity, it is assumed herein the intrusion is by a person, unless specifically stated otherwise) while reducing or minimising the Nuisance Alarm Rate (NAR). For example, a nuisance event in the context of intrusion detection may be a vibration of the fibre cable 11 caused by one of rain, wind, snow, wildlife and vegetation, as well as man-made sources such as traffic crossings, industrial noises and other ambient noise sources. The system 10 is configured to generate a detection instance in response to detection of a “target event”. Advantageously, the method may reduce the number of instances (or eliminate instances) where a “nuisance event” leads to generation of a detection instance.

FIG. 5B schematically represents the method steps of FIG. 5A. The following disclosure includes references to both figures.

At step 100, the controller 12 controls the light source 13 and signal detector 14 in order to generate a raw measurement for each of a plurality of discrete time intervals. Therefore, each time interval can correspond to a particular shot, or a plurality of shots which may be combined into a single raw measurement (e.g. via an averaging procedure). The plurality of discrete time intervals (of the order of 100 s of microseconds in length) cover a longer total period (of the order of tens of seconds in length). For example, a 60 second total period may comprise 120,000 shots at a pulse rate of 2000 pulses/second, where each shot corresponds to a single pulse. Therefore, 120,000 raw measurements are made in this example.

At step 101, the controller 12 undertakes initial processing to divide each raw measurement into a plurality of location bins, using known techniques, each location bin representing a position along the fibre cable 11.

Therefore, the output of steps 100 and 101 is a two-dimensional data structure 20 having time axis and a location axis, referred to herein as a “raw data array 20”. For the purpose of the present disclosure, each row represents a particular shot (so that the plurality of rows defines the time axis and represent changes to the raw data over time) and each column represents a particular location bin (so that the plurality of columns defines the location axis which together represent the sensing length of the fibre cable 11). For the purposes of this disclosure, where applicable, rows will generally represent a time domain and columns will represent a location domain (e.g. bins). Of course, this use of row and column is selected for ease of disclosure and is not intended to be limiting.

At step 102, the controller 12 processes the raw data array 20 for each of a plurality of preselected filters 23. Each filter 23 acts to generate a filtered array 24. Each filter 23 is unique—that is, each filter 23 corresponds to a different set of one or more data processing steps applied to the raw data array 20 (although two or more filters 23 can comprise one or more identical data processing steps, the entire set of data processing steps is unique to each filter 23). Therefore, each filtered array 24 is effectively a unique data structure when compared to each other filtered array 24. Depending on the implementation, one filter 23 can constitute no data processing such that its resulting filter array 24 is identical to the input raw data array 20.

For example, one or more filters 23 can utilise the FBR method discussed above.

Therefore, the output of these filters 23 can be a filtered array 24 corresponding to a two-dimensional array having rows representing event statistic values for each block (where, as discussed above, the blocks represent a collection of shots) and columns representing event statistic values for particular bins.

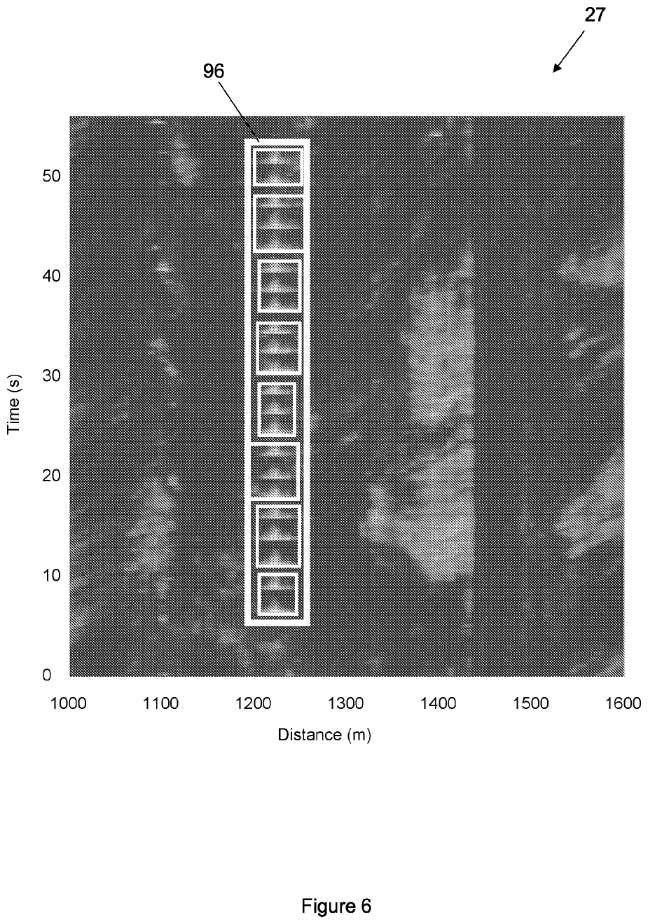

FIG. 6 shows an example of a “waterfall plot” 27 of a filtered array 24 utilising the FBR method. The waterfall plot 27 comprises event statistic values generated from real-world raw measurements, where the relative values of the event statistics is indicated by relative shading. The measured data is over a sample period of 60 s and for bins located between a distance of 1000 m and 1600 m.

In the example of FIG. 6, the real event corresponds to an “intruder” (in actual fact, a test subject) attempting to cut a fence on which the fibre cable 11 is mounted. The waterfall plot 27 shows as a series of discrete signals correlated in time and position-see box 96. As expected for fence cutting, there are (in time) a sequence of detected vibrations at the same relative location, the vibrations grouped into clearly visible discrete pulses (see vertical boxes indicating individual pulses).

Referring back to FIGS. 5A and 5B, at step 103, the filtered arrays 24 are utilised as input data for a preconfigured object identifier. The object identifier is an algorithm suitable for identifying objects in two-dimensional image data; that is, the filtered arrays 24 are treated as image data. For example, the filtered arrays can be combined into a composite (i.e. multichannel) image data structure (“composite image”) then provided to the object identifier. In another example, the object identifier can be configured to receive the filtered arrays 24 as separate inputs.

In an embodiment, the object identifier implements a Convolutional Neural Network (CNN) or another suitable machine learning algorithm which has been pretrained to identify between “visual” features (i.e. objects) representing target events(s). Typically, the object identifier is configured for positively identifying target event(s), and by implication, thereby excluding nuisance events. It should be understood that the term “target event” refers to a class of event—for example, “fence cutting” or “walking” (depending on the particular use-case)—the class being defined based on the classification scheme used when training the object identifier (discussed below). The particular target event(s) will therefore depend on the intended use of the system 10.

Each filtered array 24 is therefore assigned to a channel of the object identifier. It is already known to provide object identifying algorithms which utilise multiple colour channels of an image (e.g. for a visible colour object identifier, there are typically three channels corresponding to Red, Green, and Blue (RGB)). Embodiments herein utilise the object identification capability of a known machine learning-based object identification algorithm, for example, as may be utilised for object identification within a visible colour image (e.g. a photograph). For example, the object identifier can utilise Fast R-CNN (Reference [4]) or YOLO (References [2] and [3]). In an embodiment, different filters 23 are enabled to output filtered arrays 24 of different sizes; in this embodiment, the filtered arrays 24 are scale transformed as necessary to ensure suitability for use by the object identifier. For example, the scale of one or both axes of the filtered arrays 24 are reduced or expanded (where necessary) to a consistent size, such as the size of the smallest filtered array 24 (in terms of the particular axis).

Advantageously, by treating the filtered arrays 24 as components (channels) of an image (visually, this is represented in the waterfall plots of FIGS. 6, 7, 11, 13A, and 13B), patterns associated with events of interest can be identified by a suitably pretrained object identifier configured for identifying “visual” objects in image data (it should be noted that the term “visual” is not intended to be limiting). Advantageously, the multichannel approach herein described has been found to provide an improvement in the ability for an object identifier to identify events of interest over a single-channel approach (for example, see Examples herein). Advantageously, the methods herein described utilise a single raw data array 20 source which is processed according to different filters 23 to provide the multichannel input.

In an implementation, a training data set is utilised to train a selected object identifier (assumed to be a machine learning algorithm), thereby preconfiguring the object identifier for use in system 10. A training set comprising a plurality of “training images” is obtained, for example, from real-world operation of a distributed sensing system (such as DAS system 10). Here, each training image is derived from a raw data array 20. The training set should comprise raw arrays 20 in which the raw measurements include data generated by the desired target event(s). For the, or each, target event, there should be sufficient training images provided to enable training of the object identifier to a sufficient level of accuracy—for example, of the order of 1000 training images for each target event (although this number can vary). It can also be useful to provide training images in which a target event is not present, referred to herein as null training images. Event training images can, of course, be derived from raw data associated with several target events (in fact, a reasonable number of such images may be desirable).

In effect, each training image comprises a visually identifiable “object” for each target event represented in the training image. The pretraining comprises annotating each training image by defining a box 96 around the object and labelling the box 96 according to the represented target event (this technique may be known as a “bounding box” approach). Referring back to FIG. 6, the target event corresponds to box 96 (a person walking towards the fibre cable 11) being a visual pattern associated with a fence being cut (the fibre cable 11 being mounted to the fence). Therefore, the box 96 is annotated with “fence cutting” (or the like) to assist in training the object identifier to identify fence cutting target events. As can be seen in FIG. 6, an object can comprise discontinuous visual features.

Another target event category can be related to a person walking towards or alongside the fibre cable 11 (e.g. applicable to intruder detection). The fibre cable 11 can be buried. A visible pattern in the test data can therefore be annotated with “walking”, “human walking”, or “human walking towards boundary”, depending on the desired level of target event precision. For example, where walking is of interest, one target event can be “walking close to boundary” and another “walking far from boundary” where the boundary corresponds to the location of the fibre cable 11. Generally, the target event(s) should be preselected and consistently utilised in training (e.g. by providing an exhaustive set of labelling options for use when classifying objects in the images). Suitable machine learning algorithms for such training may be known as object detection computer vision algorithms. When utilised, null training images are simply not annotated. According to this training technique, each object is associated with a classification (what it represents) and localisation (where in the image it is located).

Relevantly, the same filters 23 intended for use at step 102 of FIG. 5A are utilised in training the object identifier. Each training image corresponds to the plurality of filtered arrays 24 generated by applying the plurality of filters 23 to its associated raw data array 20. For convenience, reference to “training image” is to the set of filtered arrays 24 derived from the same raw data element 20 (whether combined into a composite image or not). Therefore, the object identifier is effectively provided with a multichannel input comprising two or more separate channels, derived from a single raw data array 20. In the case where the filtered arrays 24 are not combined before training, in an implementation, a representative one of the filter arrays 24 can be annotated and boxed, with the annotation and boxing being applied automatically to the remaining filtered arrays 24 (before or during training of the object identifier). In the case where a composite image is created, in an implementation, it is the composite image which is annotated and boxed. Generally, annotation and boxing should enable the object identifier to identify the corresponding object and its class in each of the filtered arrays 24.

Training of the object identifier otherwise proceeds according to known training techniques. For example, the training images can be randomly assigned into a training set, a test set, and a validation set (e.g. with a 70:15:15 respective assignment ratio). Additionally, each training image can be effectively transformed into a plurality of training images through a series of image transformations (flipping, skewing, enlarging, shrinking, etc).

The number of channels utilised by the object identifier can be more than three, which may be termed a “multispectral image”. Similarly, the number of channels can be two. It is also expected that the raw data array can be filtered to generate data equivalent to a “hyperspectral image” in which each pixel comprises data representing a power spectrum detected at that pixel. The power spectrum is effectively continuous—although digital approaches naturally lead to discrete elements of the spectrum, these are arranged continuously rather at discrete intervals. The resulting hyperspectral image can be utilised in both training and real-world detection of events of interest. Image analysers suitable for object detection of hyperspectral images are known in the art.

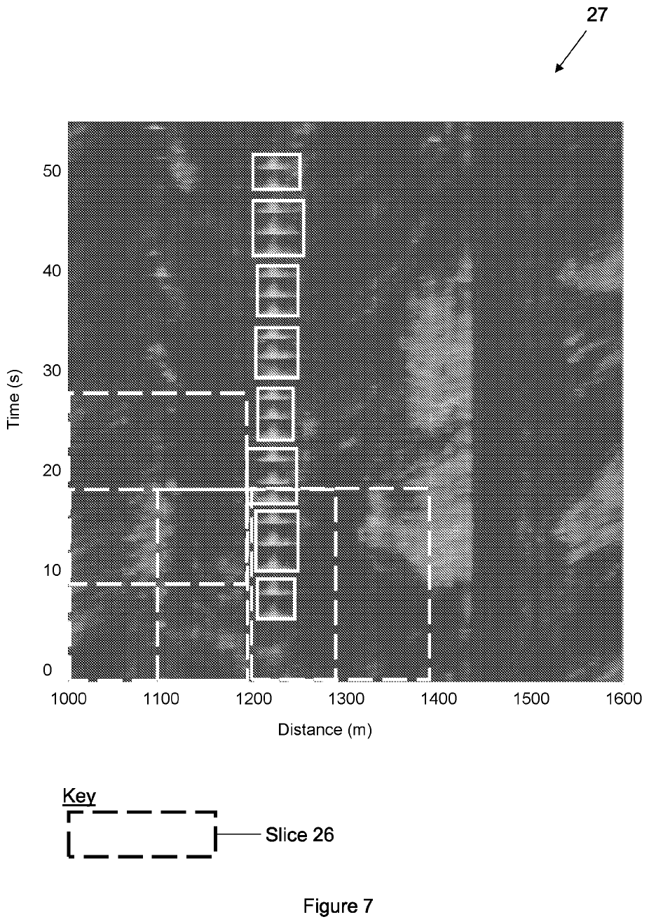

With reference to FIG. 7, in an embodiment, the object identifier is configured to analyse a series of slices 26 of the filtered arrays 24 derived from a single raw data array 20. These slices 26 are typically created after the filtering step 102, such that the object identifier performs image analysis on each of the plurality of slices 26 separately. The slices 26 can be derived by dividing up a composite image (where utilised) or, equivalently, the separate filtered images 24 can be sliced in a consistent manner such that a particular slice 24 comprises equivalent portions (with respect to time/blocks and bins) of each filtered image 24. Typically, as shown in FIG. 7, some degree of overlap between slices 26 is provided to ensure events of interest are not cut off by the edge of the slices 26. Fibre cable 11 can be >100 km long, with each bin representing ~0.5 m of this length. Therefore, the raw data array 20 can comprise a distance domain having a size of the order of >200,000 elements (i.e. >200,000 columns). This embodiment may therefore advantageously enable use of known object identifiers with realistic memory storage, by providing slices 26 for processing of a significantly reduced overall size compared to the entire size of each filtered array 24, corresponding to the data sizes for which the known object identifiers are suitable. Slicing may increase processing time while reducing memory usage-therefore, generally, a suitable trade-off is selected between slice size and memory size to ensure processing within required time frames.

Referring back to FIGS. 5A and 5B, at step 104, where the object identifier detects (at step 103) one or more instances of target events, the object identifier generates a detection event. In an embodiment, the detection event is a data structure comprising, for the (or each) detected target event, information identifying a time (or time period) at which the target event occurred, a location at which the target event occurred (e.g. a location or location range with respect to the fibre cable 11), and a target event type indicating the particular target event (where a plurality of target events are detectable by the object identifier). Typically, the detection event is stored in a non-volatile memory of the controller 12.

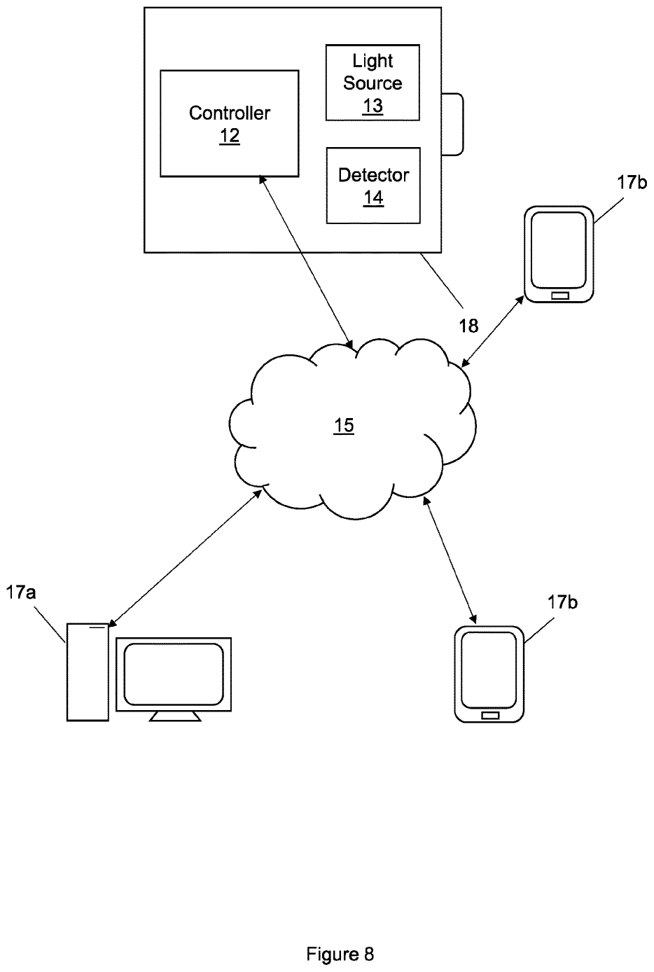

Referring to FIG. 8, in an embodiment, the controller 12 can be configured to communicate a notification, which is derived from the detection data, to a remote device 17. For example, the controller 12 can be in data communication via a network 15, which can comprise wired and/or wireless data connections. In one example, the notification is communicated to a remote device being a data server 17a configured to store the notification and/or to communicate the notification to one or more client devices 17b (e.g. smartphones) operated by authorised users. In another example, the controller 12 is configured to directly communicate the notification to one or more client devices 17b, via the network 15. The network 15 may comprise the Internet, or alternatively, may be a self-contained intranet.

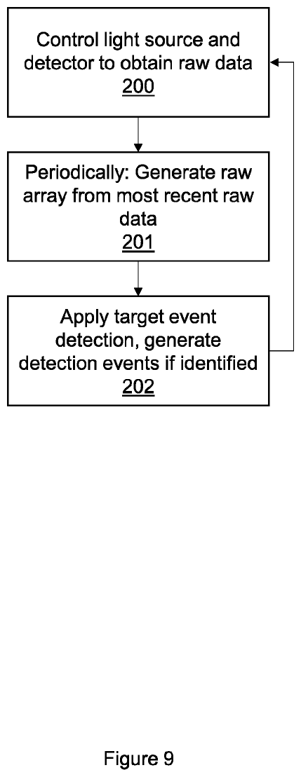

FIG. 9 shows a method, implemented by controller 12, for ongoing event detection, utilising the method of FIGS. 5A and 5B. At step 200, the controller 12 operates the light source 13 and the light signal detector 14 continuously, such that raw data is continuously being obtained and stored in a memory (e.g. a volatile or non-volatile memory of the controller 12). The controller 12 can implement a First In, First Out (FIFO) buffer of a predefined size, such that oldest data is removed to make way for newest data, when the buffer is “full”. In such a configuration, the FIFO buffer is sized at least sufficiently to contain data utilised by the raw data array 20. The FIFO buffer typically treats a row as a single data element, such that an entire oldest row is removed to make way for an entire newest row.

Periodically (e.g. according to a predefined period which may be “hardwired” or alternatively user-settable), the method moves to step 201, wherein the raw data stored in memory is utilised to generate the array data for the raw data array 20. For example, the most recent raw data corresponding to the size of the raw data array 20 is utilised-corresponding to a snapshot of the raw measurements of the most recent shots. The method then moves to step 202, wherein the method of FIGS. 5A and 5B is performed on the newly generated raw data array 20. The method then returns to step 200. It should be understood that step 200 can be ongoing, and therefore also performed “during” steps 201-202.

FIG. 9 thereby provides an approach to event detection utilising snapshots generated at a rate much slower than the rate at which the raw measurements are obtained, while retaining the intended utility of the system 10. For example, for “real time” event detection, the predefined period may be 1 minute or less. For example, a response time of 30-60 seconds may be appropriate for certain events of interest, for example, a digging event by machinery. Other events of interest may have different required response times, for example, for a walking event in relation to a fence-boundary, a response time of <10 seconds may be appropriate. In this way, “real time” has a relative meaning in that the system 10 should be capable of producing detection events within a desired timeframe of the corresponding real event occurring. In an implementation, the snapshot period is required to be at least equal to, and preferably shorter, than the time period covered by raw data array 20, to reduce the likelihood of target events not being detected by the system.

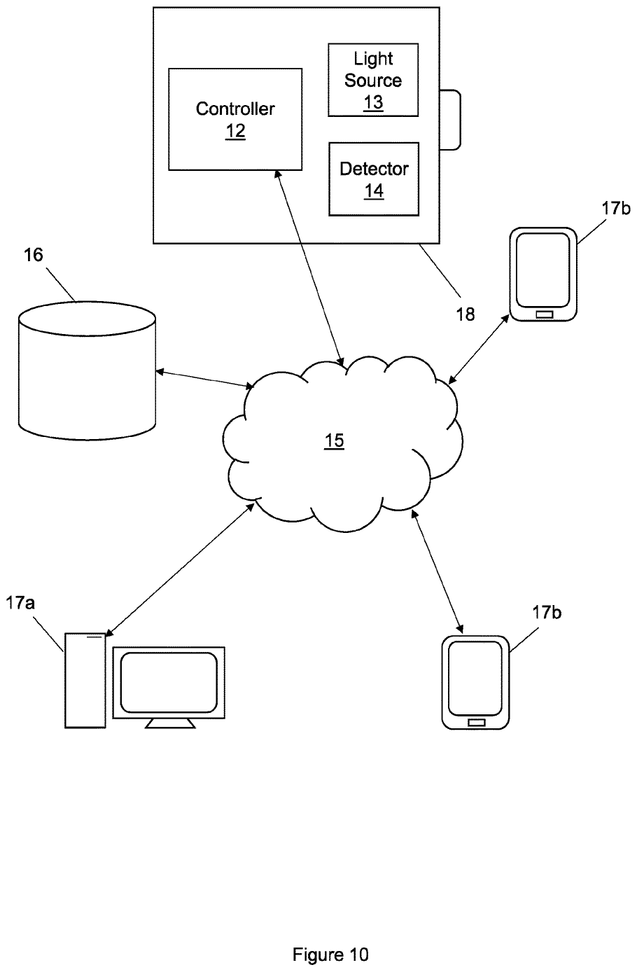

Referring to FIG. 10, in an alternative embodiment, the controller 12 is in data communication with a processing server 16 (FIG. 10 shows a modification to the embodiment of FIG. 8). The controller 12 is configured to provide raw data, or pre-processed data, to the processing server 16. However, the processing server 16 is configured to perform the event detection method (e.g. as per FIGS. 5A and 5B). The data communication can be via a network 15 (as shown), which can comprise the Internet or may be contained within an intranet. In another variation (not shown), the processing server 16 is in direct data communication, for example, via a wired serial data protocol such as USB or Ethernet. The embodiment of FIG. 10 can also be utilised where real-time event detection is not necessarily required and, instead, the raw data is retained (with or without pre-processing) by the processing server 16 for forensic purposes.

The particular filters 23 utilised can depend on the particular target events—that is, it can be that different combinations of filters 23 are effective for different target events of interest. Additionally, there can be processing trade-offs where a preferred combination of filters 23 provides a satisfactory efficiency at identifying target events accounting for the processing resource limitations of the controller 12. For example, event monitoring can be required to be performed in “real-time”—that is, events are identified relatively soon after the corresponding real event—which may depend on the particular processing capability of the controller 12.

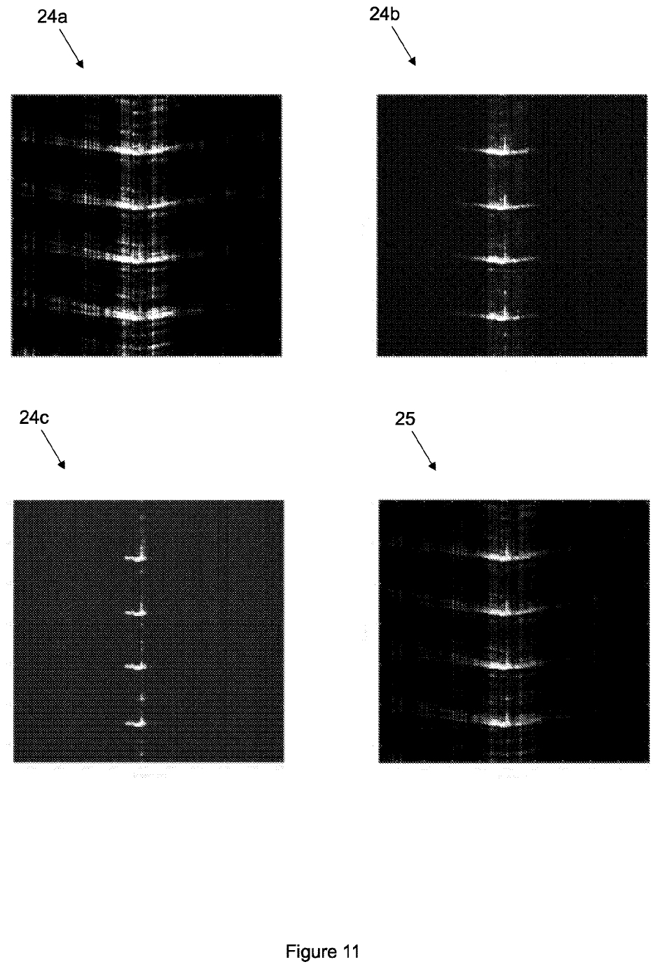

Referring to FIG. 11, in one embodiment, two or more filters 23 utilise the FBR method, differing in the particular parameterisation of the method—thereby ensuring the filters 23 produce distinct filtered arrays 24. In the present case, at least the signal band of each filter 23 differs, such that first filter 23a has a frequency band of 2.5-20 Hz, second filter 23b has a frequency band of 30-50 Hz, and third filter 23c has a frequency band of 80-150 Hz. The output of the FBR method is a plurality of filtered arrays 24a, 24b, 24c. In an implementation, the signal bands of the filters 23 are discontinuous with respect to each other—that is, there exists a range of frequencies between each signal band. FIG. 11 shows plots of each resulting filtered array 24a, 24b, 24c as well as a composite array 25 in which the three filtered arrays 24a, 24b, 24c are combined. The composite array 25 is shown as a composite image in false colour—each filtered array 24 is assigned a colour of a display channel (e.g. filtered array 24a is assigned RED, filtered array 24b is assigned GREEN, and filtered array 24c is assigned BLUE of an RGB image). The composite array 25 is therefore displayed in a manner enabling a user to distinguish elements of each filtered array 24 which are common (shown as a mixing of RED, GREEN, and BLUE) and unique (shown as RED, GREEN, or BLUE with little or no mixing).

Other filters 23 can be utilised than the particular example of FIG. 11. In one implementation, one or more channels can be associated with the FBR method using a Fast Fourier Transform while another one or more other channels can be associated the FBR method using a Wavelet Transform approach. More generally, different filters 23 can be associated with different domain transforms selected from known transforms applicable to two-dimensional images.

Another filter 23 (or set of two or more filters 23) can implement the “level crossing” approach, as described in Applicant's granted U.S. Pat. No. 8,704,662, the content of which is incorporated herein by reference.

Other filters 23 can take a block of raw data and process to determine the Root Mean Square (RMS) or maximum value of the raw measurement at each bin, optionally with additional pre-filtering.

The particular filters 23 utilised can be determined through trial-and-error, although it is anticipated that a user may select particular filters 23 based on experience. For example, it may be known that a particular target event (such as walking) is particularly strongly represented in certain discrete frequency ranges.

It is also expected that a systematic approach based on test data can be utilised to not only train the object identifier, but to determine the particular set of filters 23 that optimally identify one or more target events (an “optimisation approach”). For example, machine learning, genetic algorithms, neural networks, or statistical techniques (such as utilised Bayesian techniques) can be utilised to test combinations of various filters to identify one or more combinations which meet a quality threshold, or to simply identify the most optimal combination. Such an approach can be constrained to ensure the particular combination of filters 20 can be implemented by the controller 12 while meeting required processing performance targets (e.g. that events can be identified with a required time period of the real event occurring). The filters 23 can be selected from a set of allowable filter types. The optimisation approach can determine one or more parameters for a selected filter type (whether provided as an input or determined by the optimisation approach). Therefore, either or both of a filter type and parameter(s) for said filter type can be determined using the optimisation approach. Also, or alternatively, an optimal number of predefined filters is determined using the optimisation approach. Typically, the optimisation approach is subject to constraints, such allowable filter types, allowable parameter values for particular filter types, and/or allowable numbers of filters 23. Another constraint can relate to the processing resources available for implementing the object analyser.

Embodiments herein described utilise multichannel object detection in identifying events of interest (detection events) in the raw measurement data generated by system 10. Relevantly, the raw data generated by the system 10 is not inherently multichannel—there is one fibre cable 11 utilised and one combination of light source 13 and detector 14. The described embodiments utilise different signal processing techniques applied to the raw data, which has been found to improve the reliability of the object identifier in identifying events of interest when compared to a one channel approach to object identification.

One of the features of some object detection algorithms, which can be incorporated into the object identifier, is that with each detection a confidence level is calculated for each detection (for example, between 0 and 1). In an embodiment, the controller 12 can be configured to enable a user to set a confidence threshold to adjust the sensitivity of the system 10. Finding an ideal sensitivity requires a balance between maximising the POD while minimising the NAR. A theoretically ideal system 10 would have a sensitivity region where there are no nuisance events, and while all target events are detected.

Although the description herein has focused on an amplitude-based DAS system, it is expected that the methods herein described are applicable to data generated by other distributed sensor systems utilising a fibre optic 11 sensor. For example, other suitable systems can include: Distributed Temperature Sensing (DTS) systems, Brillouin Optical Time-Domain Reflectometer (BOTDR) systems, and true-phase based Distributed Acoustic Sensor (DAS) systems. Generally, distributed sensing systems which make raw measurements which are suitable for generating a two-dimensional data array having “objects” (i.e. visual features when the two-dimensional array is processed as a multichannel image) which correspond to time and location specific events of interest may be utilised.

### Example 1: First Experimental Result

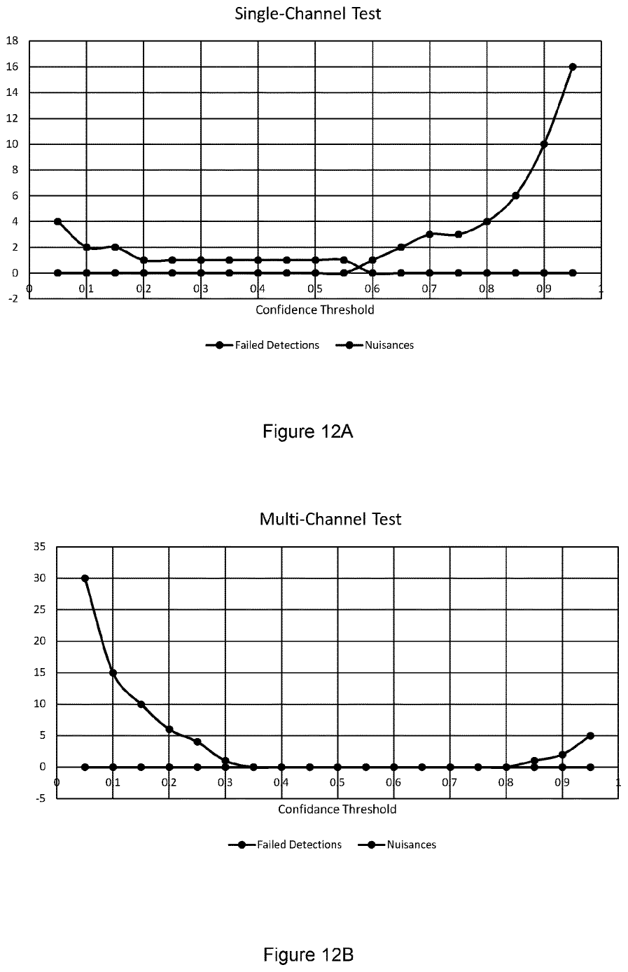

Referring to FIGS. 12A and 12B and Table One and Table Two below, actual raw data obtained from a system 10 implemented in a real-world installation is processed according to the methods described herein and compared to a single-channel object detector approach (such as described in References [8], [9], an [10]).

The events of interest (i.e. target events) include fence cuts and fence climbs on a fence mounted intrusion detection system. The raw data was broken up into two sets: one for training models; and a test set. The test set included 69 intrusions and several files with background data where there were high winds present (representing potential nuisance events).

The raw data was processed by using a single frequency band (i.e. a one channel approach using the FBR method), referred to herein as the “Single-Channel Test”. Monochrome images, for both training and testing, were generated from this data and utilised by a single channel object identifier.

The same raw data was also processed using the methods herein described, in particular with reference to FIGS. 5A and 5B, to create three-channel images for both training and testing (“Multichannel Test”). The same parameterisation was utilised in creating each image—that is, the same three filters 23a, 23b, 23c. In this case, each filter 23 utilised the FBR method (FFT) and differed in the frequency ranges for each signal band. The single band used for the Single-Channel test was 400-2500 Hz, the multichannel bands used for the Multichannel Test were 200-800 Hz, 800-1500 Hz, and 1500-2500 Hz.

TABLE 1
Example 1 - Single-Channel Test Data
Single Channel Test

| | Failed | | | Confidence | |
|---|---|---|---|---|---|
| Intrusions | Detections | Detections | Nuisances | Threshold | POD |
| 69 | 0 | 69 | 4 | 0.05 | 1 |
| 69 | 0 | 69 | 2 | 0.1 | 1 |
| 69 | 0 | 69 | 2 | 0.15 | 1 |
| 69 | 0 | 69 | 1 | 0.2 | 1 |
| 69 | 0 | 69 | 1 | 0.25 | 1 |
| 69 | 0 | 69 | 1 | 0.3 | 1 |
| 69 | 0 | 69 | 1 | 0.35 | 1 |
| 69 | 0 | 69 | 1 | 0.4 | 1 |
| 69 | 0 | 69 | 1 | 0.45 | 1 |
| 69 | 0 | 69 | 1 | 0.5 | 1 |
| 69 | 0 | 69 | 1 | 0.55 | 1 |
| 69 | 1 | 68 | 0 | 0.6 | 0.985507 |
| 69 | 2 | 67 | 0 | 0.65 | 0.971014 |
| 69 | 3 | 66 | 0 | 0.7 | 0.956522 |
| 69 | 3 | 66 | 0 | 0.75 | 0.956522 |
| 69 | 4 | 65 | 0 | 0.8 | 0.942029 |
| 69 | 6 | 63 | 0 | 0.85 | 0.913043 |
| 69 | 10 | 59 | 0 | 0.9 | 0.855072 |
| 69 | 16 | 53 | 0 | 0.95 | 0.768116 |

TABLE 2
Example 1 - Multi-Channel Test Data
Multichannel Test

| | Failed | | | Confidence | |
|---|---|---|---|---|---|
| Intrusions | Detections | Detections | Nuisances | Threshold | POD |
| 69 | 0 | 69 | 30 | 0.05 | 1 |
| 69 | 0 | 69 | 15 | 0.1 | 1 |
| 69 | 0 | 69 | 10 | 0.15 | 1 |
| 69 | 0 | 69 | 6 | 0.2 | 1 |
| 69 | 0 | 69 | 4 | 0.25 | 1 |
| 69 | 0 | 69 | 1 | 0.3 | 1 |
| 69 | 0 | 69 | 0 | 0.35 | 1 |
| 69 | 0 | 69 | 0 | 0.4 | 1 |
| 69 | 0 | 69 | 0 | 0.45 | 1 |
| 69 | 0 | 69 | 0 | 0.5 | 1 |
| 69 | 0 | 69 | 0 | 0.55 | 1 |
| 69 | 0 | 69 | 0 | 0.6 | 1 |
| 69 | 0 | 69 | 0 | 0.65 | 1 |
| 69 | 0 | 69 | 0 | 0.7 | 1 |
| 69 | 0 | 69 | 0 | 0.75 | 1 |
| 69 | 0 | 69 | 0 | 0.8 | 1 |
| 69 | 1 | 68 | 0 | 0.85 | 0.985507 |
| 69 | 2 | 67 | 0 | 0.9 | 0.971014 |
| 69 | 5 | 64 | 0 | 0.95 | 0.927536 |

For the Single-Channel Test, with the particular test data, there is no confidence threshold setting that produces 100% detection rate (POD=1) with 0 nuisances, whereas the Multichannel Test using three frequency bands has a range in the confidence sensitivity from 0.35-0.8 where 100% detection (POD=1) and a 0 nuisance can be achieved. Therefore, the multichannel approach, despite using the same training data and test data as the single channel approach, produced a noticeable improvement when compared to the single-channel approach, providing a range of sensitivities for which there were no failed detections and 100% detection of target events.

### Example 2: Second Experimental Result

A comparison between the Applicant's “classic” approach to event detection and the approach described herein (“disclosed method”) was made of test data. That is, the classic approach does not utilise an object recognition approach—the approach is consistent, for example, with the methodologies described in Reference [5] and Reference [6].

The test data was obtained from a real-world site in which detection of digging, walking, and vehicles were desired. Three filters 23 were utilised, each implementing the FBR method with a common noise band of 1100-1250 Hz (due to sound attenuation, these frequencies ae usually only associated with noise). However, the filters 23 differed in the signal bands, specifically the filters 23 corresponded to the following bands:

| | | | |
|---|---|---|---|
| First filter 23a: | Low | =2.5-20 | Hz |
| Second filter 23b: | Medium | =30-60 | Hz |
| Third filter 23c: | High | =80-150 | Hz |

These rangers were selected to reflect different detection properties. The high frequency band is typically used to detect high energy close events such as digging within a few meters of the cable, the medium frequency band is typically sensitive to events more distant from the fibre cable 11 at around 10-20 m (this can vary a lot based on soil conditions). The low frequency band is usually used to detect walking close to the fibre cable 11 but is also susceptible to noise from greater distances.

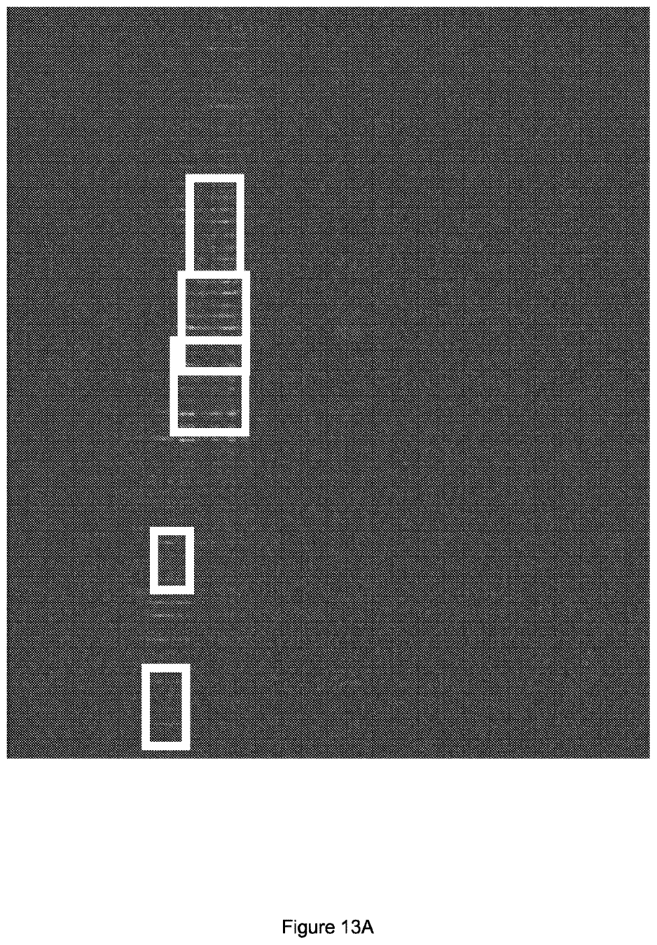

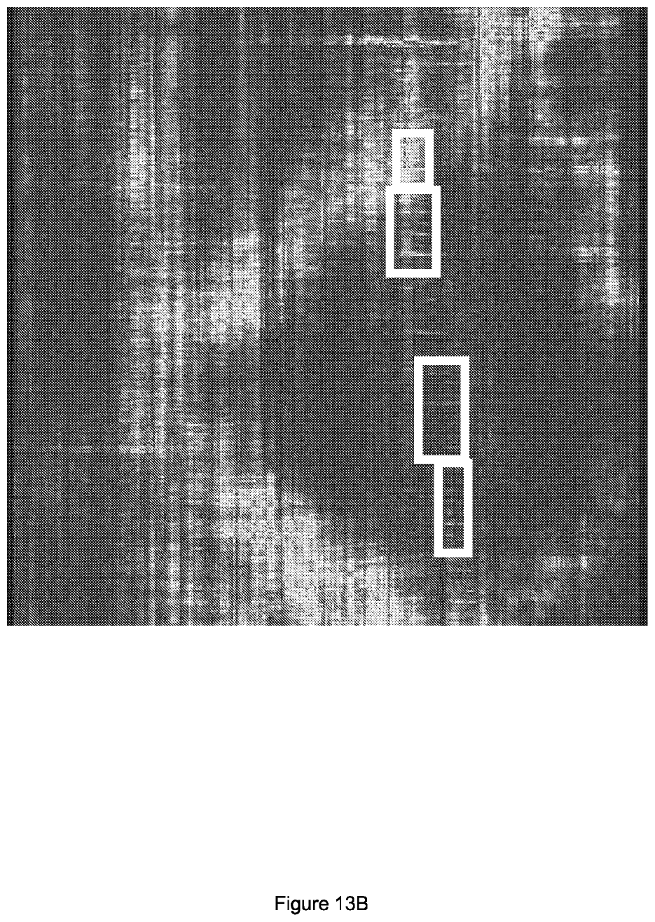

As shown in FIG. 13A, the walking signal (indicated with the enclosed areas of the overlaying boxes) is very faint (noticeable even without significant noise), and therefore difficult for the classic approach to identify (which is based on signal strength). FIG. 13B shows an example showing faint walking signals detected by the disclosed method (enclosed by boxes), successfully excluding other (nuisance) signals (this particular was not utilised in the testing results below but was provided to the object identifier).

The test data was separated into test data representing walks, vehicles, and nearby aircraft. For ease of analysis this data was chosen to include minimal other activities. For example, all walks contained no background noise, vehicle and aircraft was chosen to contain minimal human activity. It should be noted that some of the vehicle and aircraft data are likely to contain some legitimate human activity as the site is so busy, but from viewing the data alone it is not always easy to isolate this activity.

TABLE 3
Example 2 - Test Results

| | |
|---|---|
| Classic Approach | Disclosed Method |

Walking (Number of Test Data Files = 11)

| | | |
|---|---|---|
| Total Number of Detections | 6 | 55 |
| Files with Detections | 4 | 11 |
| Files with No Detections | 7 | 0 |
| POD | 36% | 100% |

Vehicles (Number of Test Data Files = 8)

| | | |
|---|---|---|
| Total Number of Nuisances | 134 | 14 |

Aircraft (Number of Test Data Files = 5)

| | | |
|---|---|---|
| Total Number of Nuisances | 667 | 12 |

These results show an order of magnitude of improvement from the classic approach to the methodology herein described, in both sensitivity and nuisance suppression. Sensitivity is increased by a factor of ~10 and nuisance rates are decreased by a factor of ~10 for vehicles and by a factor of ~50 for aircraft signals.

The methods herein described can be implemented by the controller 12 and/or processing server 16 responsive to a computer program stored within a memory of the relevant device. The computer program comprises code configured to cause the processor(s) of the relevant device to implement the methods herein described responsive to execution of said code. The computer program can be embodied in a computer readable storage medium, which can allow for the computer program to be loaded into the memory of the controller 12 and/or processing server 16. For example, the computer readable storage medium can allow a legacy controller 12 or processor 16 to be updated to enable the functionality herein described.

While the invention has been described with respect to the figures, it will be appreciated that many modifications and changes may be made by those skilled in the art without departing from the spirit of the invention. Any variation and derivation from the above description and figures are included in the scope of the present invention as defined by the claims.

### REFERENCES

[1] Tejedor, J., Macias-Guarasa, J., Martins, H. F., Pastor-Graells, J., Corredera, P., & Martin-Lopez, S. (2017). Machine learning methods for pipeline surveillance systems based on distributed acoustic sensing: A review. Applied Sciences, 7 (8), 841.
[2] Redmon, J., & Farhadi, A. (2018). Yolov3: An incremental improvement. arXiv preprint arXiv: 1804.02767.
[3] Bochkovskiy, A., Wang, C. Y., & Liao, H. Y. M. (2020). Yolov4: Optimal speed and accuracy of object detection. arXiv preprint arXiv: 2004.10934.
[4] Ren, S., He, K., Girshick, R., & Sun, J. (2015). Faster r-cnn: Towards real-time object detection with region proposal networks. Advances in neural information processing systems, 28, 91-99.
[5] U.S. Pat. No. 8,704,662 (Mahmoud et al.), dated 22 Apr. 2014.
[6] International (PCT) Patent Application No. PCT/AU2019/050303, published as WO 2019/191815 A1, dated 10 Oct. 2019.
[7] Website entitled “Everything You Ever Wanted To Know About Computer Vision”, dated 26 Apr. 2019, available at: https://towardsdatascience.com/everything-you-ever-wanted-to-know-about-computer-vision-heres-a-look-why-it-s-so-awesome-e8a58dfb641e
[8] Stork, A. L., Baird, A. F., Horne, S. A., Naldrett, G., Lapins, S., Kendall, J. M., . . . & Williams, A. (2020). Application of machine learning to microseismic event detection in distributed acoustic sensing data. Geophysics, 85 (5), KS149-KS160.
[9] Zhu, X., & Shragge, J. Toward Real-time Microseismic Event Detection using Machine Learning.
[10] Sha, Z., Feng, H., Rui, X., & Zeng, Z. (2021). PIG Tracking Utilizing Fibre Optic Distributed Vibration Sensor and YOLO. Journal of Lightwave Technology, 39 (13), 4535-4541.
[11] Nataprawira, J., Gu, Y., Goncharenko, I., & Kamijo, S. (2021). Pedestrian detection using multispectral images and a deep neural network. Sensors, 21 (7), 2536.
[12] Gani, M. O., Kuiry, S., Das, A., Nasipuri, M., & Das, N. (2021 January). Multispectral Object Detection with Deep Learning. In International Conference on Computational Intelligence in Communications and Business Analytics (pp. 105-117). Springer, Cham

1. A computer-implemented method for identifying events of interest detected by a distributed sensor system, the method comprising the steps of:
obtaining a raw data array generated from raw measurements made by a distributed sensor system comprising a fibre optic cable optically coupled to a light source and a light signal detector for a plurality of discrete time intervals, wherein each raw measurement is processed to create a plurality of bins, wherein each bin is uniquely associated with a location along the fibre cable and comprises signal data associated with said location, and wherein the raw data array comprises a time axis corresponding to the plurality of discrete time intervals and a location axis corresponding to the plurality of bins;
separately processing the raw data array according to a plurality of predefined filters, where each filter is unique and receives the raw data array as an input and generates a filtered array as an output; and
processing the plurality of filtered arrays using an object identifier, wherein the object identifier is configured to:
treat the plurality of filtered arrays as separate channels of a multichannel image and thereby processes the plurality of filtered arrays as a multichannel image,
perform a preconfigured image recognition operation to identify objects, within the multichannel image, corresponding to one or more predefined target events, and
in response to identifying one or more objects corresponding to the one or more predefined target events, generate a detection event for the, or each, identified object identifying at least a location along the fibre optic cable associated with the presence of the object,
wherein the one or more target events each correspond to a particular type of event of interest intended for detection by the distributed sensor system, and wherein each object is representative of a signal detected by the distributed sensor system at the corresponding location.

2. A method as claimed in claim 1, wherein each object corresponds to vibrations detected by the fibre optic cable at the corresponding location along its length.

3. A method as claimed in claim 2, wherein the distributed sensor system is utilised for intrusion detection and wherein at least one target event corresponds to an intrusion event.

4. The method as claimed in claim 1, wherein the method is implemented by a controller and wherein the controller is configured to operate the light source and the light signal detector to generate the raw measurements or
wherein the method is implemented by a processing server in data communication with a controller, wherein the controller is configured to operate the light source and the light signal detector to generate the raw measurements, and to communicate the raw measurements to the processing server.

5. (canceled)

6. The method as claimed in claim 1, wherein the object identifier comprises a pretrained machine learning algorithm for implementing the preconfigured image recognition operation.

7. The method as claimed in claim 6, wherein the machine learning algorithm is trained using a training set comprising a plurality of annotated filtered arrays derived from raw data training arrays, wherein each raw data training array comprises one or more events of interest represented in its raw measurements, and wherein each filtered array is annotated to indicate a predefined target event type associated with the, or each, event of interest.

8. The method as claimed in claim 7, wherein each annotation includes localisation information indicated the location of the event of interest within the associated filtered arrays or
wherein annotations are provided by annotating a multichannel training image derived from the filtered arrays derived from a particular raw data training array, each channel of the multichannel image thereby corresponding uniquely to an output of one of the plurality of predefined filters or
wherein annotations are provided by annotating a multichannel training image derived from the filtered arrays derived from a particular raw data training array, each channel of the multichannel image thereby corresponding uniquely to an output of one of the plurality of predefined filters.

9. (canceled)

10. The method as claimed in claim 6, wherein an optimisation procedure is utilised to determine an optimal filter type and/or at least one optimal parameter value for at least one of the predefined filters, and/or to determine an optimal number of predefined filters or
wherein the optimisation procedure is subject to constraints selected from one or more of: allowable filter types, allowable parameter values for particular filter types, and/or allowable numbers of filters.

11. (canceled)

12. The method as claimed in claim 1, wherein the raw data array comprises a signal value derived from the measurement data for each bin at each discrete time interval.

13. The method as claimed in claim 1, wherein at least one predefined filter generates a filtered array comprising an event statistic value for each bin associated with one or a continuous range of discrete time intervals or wherein the event statistics are generated using a calculation comprising one or more: a Frequency Band Ratio (FBR), a power spectral density, a level crossing calculation, a raw measurement amplitude, and a raw measurement phase.

14. (canceled)

15. The method as claimed in claim 13, wherein at least two filters utilise a same event statistic generation method differentiated by a setting of at least one parameter associated with the event statistic generation method or
wherein the at least two filters differ according to a frequency range parameter when using a Fast Fourier Transform or wherein the at least two frequency range parameters are non-continuous in the frequency domain.

16. (canceled)

17. (canceled)

18. The method as claimed in claim 1, wherein the at least two filters differ according to one or more wavelet transform parameters or
wherein the at least two filters differ according to one or more of: a discrete cosine transform (DCT), a discrete sine transform (DST), and one or more other mathematical transform parameters, or
wherein at least two filters utilise a different event statistic generation method or wherein one or more of the filtered arrays are scaled to provide a consistent size for each filtered array for creating the multichannel image.

19. (canceled)

20. (canceled)

21. (canceled)

22. The method as claimed in claim 1, wherein in response to generating a detection event, communicating a notification to a recipient device providing information about the detection event including at least a location along the fibre optic cable associated with the detection event or
wherein the distributed sensor system is an amplitude based Distributed Acoustic Sensing (DAS) system or
wherein the distributed sensor system is selected from: a Distributed Temperature Sensing (DTS) system, a Brillouin Optical Time-Domain Reflectometer (BOTDR) system, and a true-phase based Distributed Acoustic Sensor (DAS) system.

23. (canceled)

24. (canceled)

25. The method as claimed in claim 1, wherein the step of separately processing the raw data array according to a plurality of predefined filters comprises generating slices of the filtered arrays, such that each slice is processed separately by the object identifier and
wherein the slices are arranged such that adjacent slices comprise overlapping portions of the filtered arrays.

26. (canceled)

27. The method as claimed in claim 1, comprising three predefined filters or
comprising four or more predefined filters corresponding to a multispectral image.

28. (canceled)

29. A computer-implemented method for identifying events of interest detected by a distributed sensor system, the method comprising the steps of:
obtaining a plurality of filtered arrays, each filtered array obtained as an output of an associated filter applied to a raw data array, wherein each filter is unique, and wherein the raw data array is generated from raw measurements made by a distributed sensor system comprising a fibre optic cable optically coupled to a light source and a light signal detector for a plurality of discrete time intervals, wherein each raw measurement is processed to create a plurality of bins, wherein each bin is uniquely associated with a location along the fibre cable and comprises signal data associated with said location, and wherein the raw data array comprises a time axis corresponding to the plurality of discrete time intervals and a location axis corresponding to the plurality of bins; and
processing the plurality of filtered arrays using an object identifier, wherein the object identifier is configured to:
treat the plurality of filtered arrays as separate channels of a multichannel image and thereby processes the plurality of filtered arrays as a multichannel image, and
perform a preconfigured image recognition operation to identify objects, within the multichannel image, corresponding to one or more predefined target events,
wherein the one or more target events each correspond to a particular type of event of interest intended for detection by the distributed sensor system, and wherein each object is representative of a signal detected by the distributed sensor system at the corresponding location.

30. The computer-implemented method for ongoing detection of events of interest, the method comprising the steps of:
continuously obtaining raw measurements from a distributed sensing system;
periodically performing the method of claim 1, using a most recent set of the obtained raw measurements to generate the raw data array.

31. A controller configured to operate a light source and light signal detector of a distributed sensing system, the controller configured to obtain raw measurements from the light signal detector, and further configured to implement the method of claim 1, wherein the controller generates the raw signal array from the raw measurements.

32. A distributed sensing system comprising a controller, a light source, a light signal detector, and a fibre optic cable, wherein the light source and light signal detector are optically coupled to the fibre optic cable an wherein the controller is configured to operate the light source and light signal detector, the controller configured to obtain raw measurements from the light signal detector, and further configured to implement the method of claim 1, wherein the controller generates the raw signal array from the raw measurements.

33. A computer program comprising code configured to cause a processor to implement the method of claim 1 when said code is executed by said processor.

34. (canceled)
